(19) United States
(12) Patent Application Publication
(10) Pub. No.: US 2022/0025091 A1
(43) Pub. Date: Jan. 27, 2022

(54) RESIN FOR DESALINATION AND PROCESS OF REGENERATION

(71) Applicant: NewSouth Innovations Pty Limited, Sydney, New South Wales (AU)

(72) Inventors: Richard Mark Pashley, Cook, Australian Capital Territory (AU); Mojtaba Taseidifar, Franklin, Australian Capital Territory (AU); Tanita Gettongsong, Bruce, Australian Capital Territory (AU)

(21) Appl. No.: 17/312,221

(22) PCT Filed: Dec. 12, 2019
(86) PCT No.: PCT/AU2019/051367

§ 371 Date: Jun. 9, 2021

(30) Foreign Application Priority Data
Dec. 12, 2018 (JP) 2018904715

(51) Int. Cl. C08F 220/60; C08G 73/02; B01J 43/00; B01J 49/50; C02F 1/42

(52) U.S. Cl. CPC C08F 220/60; C08G 73/0253; C02F 2103/08; B01J 49/50; C02F 1/42; B01J 43/00

(57) ABSTRACT

Disclosed is an ion exchange resin comprising a polymer having strong acid and strong base groups on the same polymer. In some forms the resin comprises a high density of polymers having strong acid and strong base groups on the same polymer. In some forms the strong acid and strong base groups are in close proximity to one another on the polymer. The disclosure further relates to a mixed bead resin for high salt level desalination.

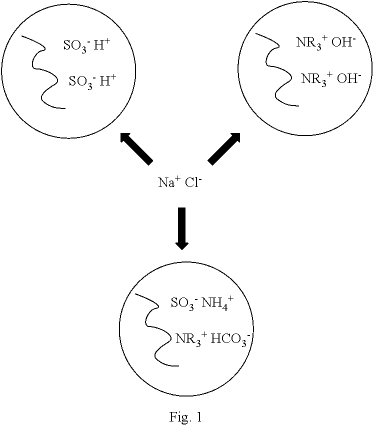

### TECHNICAL FIELD

This disclosure relates, in general, to a resin for providing improved desalination efficiency and to a process of regeneration of the resin.

### BACKGROUND ART

In known commercial applications, anion exchange and cation exchange resin beads are mixed together to produce a combined ion exchange effect. Because the anion exchange resin beads and cation exchange resin beads are regenerated separately via acid and base washing, the mixed beads must be able to be separated. The densities of the beads are commonly different, to facilitate simple separation of the resin beads.

The demand for fresh water is high. Around 1.2 billion people lack access to clean and safe drinking water currently with an expected even higher demand for clean and safe drinking water in the current century. To address this issue, various desalination technologies have been designed to improve global access to clean and safe drinking water. Common techniques for large scale desalination of sea water to form drinking water include distillation and reverse osmosis. Distillation and reverse osmosis are energy intensive processes.

Ion exchange (IEX) resins have been used for many years in various water treatment related practices. For example, mixed-bed ion exchange resins have been used to remove scale-forming ions, such as Ca₂+ and Mg₂+, from feedwater and to produce high quality water (i.e. comparable to distilled water) from tap water. Such resins could also be used, potentially, for the desalination of fairly concentrated brackish water and even seawater, without the need for high pumping pressures, extensive pre-treatment or high thermal energy input. However, utilization of ion-exchange resins on a large scale for desalination of water has been limited by the depletion of the resin and the need for large volumes of acid and base solutions to regenerate the spent resins, limiting the economic viability of the technique.

An ion-exchange resin may be referred to as “spent” when the majority of the mobile counter-ions associated with the charged functional groups in the resin have been replaced with the other ions of similar charge. During a typical desalination process using an ion-exchange resin, for example, a desalination process to remove NaCl from water, the water passes through (i.e. elutes through) both a cation-exchange resin, in which the mobile counter-ion is exchanged with the cation (e.g. Na+) in the water, and an anion-exchange resin, in which the mobile counter-ion is exchanged with the anion (e.g. Cl−) in the water. For a typical desalination process for producing drinking water, the mobile counter-ion of the cation-exchange resin is typically H+ and the mobile counter-ion of the anion-exchange resin is typically OH−. Typically, the cation-exchange resin and the anion-exchange resin are in the form of beads housed in an ion-exchange column.

To regenerate the spent resin, the resin beads are firstly separated into the beads of the cation-exchange resin and the beads of the anion-exchange resin, and each component is then washed separately with a regenerating solution. A regenerating acid solution is used to wash and thereby remove the exchanged cation on the cation-exchange resin. A regenerating basic solution is used to wash and thereby remove the exchanged anion on the anion-exchange resin. Further washing steps (usually using the product water) are then subsequently used to rinse the regenerating solution away from the resin.

Some alternative methods have been investigated to regenerate IEX resins, such as thermal energy, electrical energy (electrodialysis) or mechanical energy (piezodialysis). For example, in the Sirotherm™ process developed by CSIRO, resin beads containing both a weak acid component and a weak base component were formed (using either a physical mixture of a weakly acidic resin and a weakly basic resin, or a resin containing both weakly acidic and weakly basic components), having a substantially reduced ion adsorption capacity at higher temperatures, allowing the resins to be regenerated by heating, e.g. to 60° C. to 80° C. This process has only been used to dilute brackish water and is currently not used on a large scale as it requires large energy investment during the heat treatment step. Furthermore, repeated heating of the ion-exchange resin over numerous cycles was found to decompose the resin.

The above references to the background art do not constitute an admission that the art forms a part of the common general knowledge of a person of ordinary skill in the art. The above references are also not intended to limit the application to actuators, methods of fabrication of an actuator and its composition as disclosed herein.

### SUMMARY

Disclosed is an ion exchange resin comprising a polymer having strong acid and strong base groups on the same polymer. In some forms the resin comprises a high density of polymers having strong acid and strong base groups on the same polymer. In some forms the strong acid and strong base groups are in close proximity to one another on the polymer. The disclosure further relates to a mixed bead resin for high salt level desalination.

The disclosed ion exchange resin may have the benefit of providing for efficient ion exchange or desalination and may also have the benefit of efficient regeneration. The broad concept of a resin comprising strong acid and strong base groups on a single polymer within the resin creates this efficiency of ion exchange due to the closeness of the groups (within nanometres rather than millimetres of one another). The efficiency of ion exchange or desalination may be improved because the location of the exchanging ions is relatively close. The regeneration of this resin requires a new method which is also disclosed herein.

The resin material may allow for the simultaneous exchange of anions and cations, within the same molecular group, which may improve the efficiency of desalination, especially at the higher concentrations approaching seawater levels. Sustainable and low energy desalination for brackish water offers a viable alternative to reverse osmosis in many areas which can be used in combination with a novel membrane process for the closed-cycle regeneration of the resin.

According to a first aspect, disclosed is an ion exchange resin, the resin comprising strong acid and strong base groups on the same polymer chain. In some forms either a chemically cross-linked ampholytic polymer resin or a cross-linked zwitterionic polymer resin are located on the same polymer chain, wherein the ampholytic polymer resin and the zwitterionic polymer resin each contain strong acid and base groups on the same polymer chain. In some forms the ion exchange resin is provided for high salt level water desalination.

Also disclosed is a process of regeneration of an ion-exchange resin, the process comprising washing the resin with concentrated ammonium bicarbonate solution. In some forms recovery is performed with hollow fibre membranes and used in closed cycle resin regeneration. This method of regeneration could also be applied to spent inorganic ion exchange materials, such as zeolites.

### BRIEF DESCRIPTION

Notwithstanding any other forms that may fall within the scope of the process and apparatus as set forth, specific embodiments will now be described, by way of example only, with reference to the accompanying drawings in which:

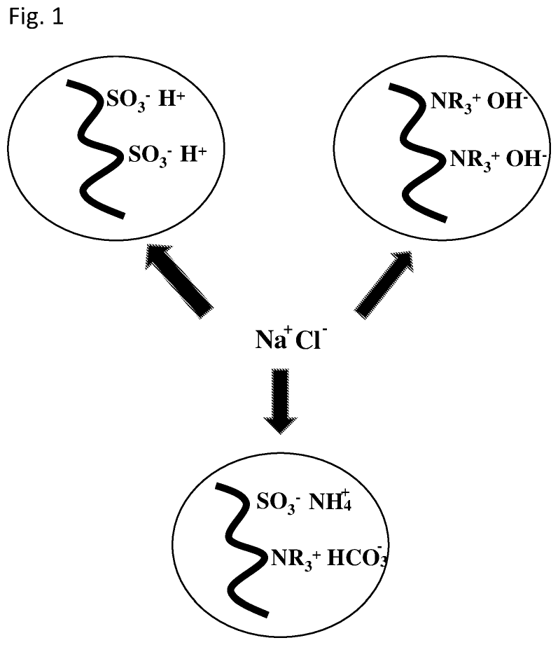

FIG. 1 shows a schematic diagram of the difference between separate bead ion exchange and ion exchange on the same polymer.

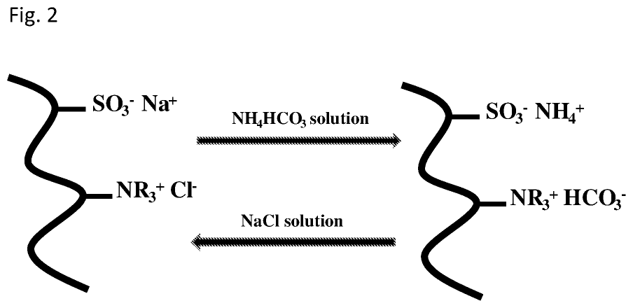

FIG. 2 shows a schematic diagram of ion exchange regeneration using ammonium bicarbonate solutions.

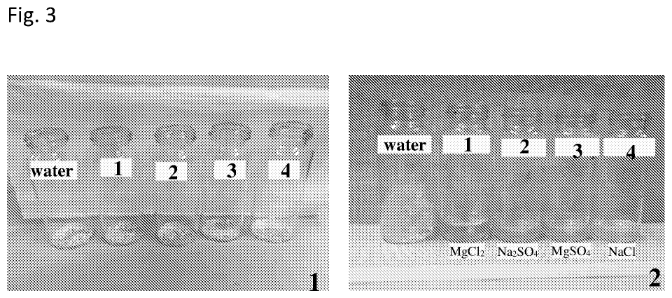

FIG. 3 shows swelling of a gel resin of one embodiment of the disclosure in salt solutions having a range of concentrations.

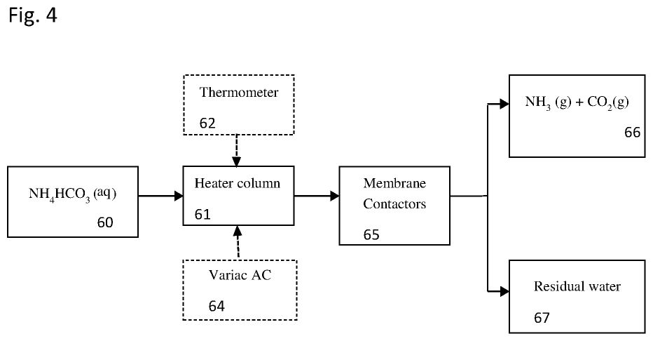

FIG. 4 shows a schematic diagram of the membrane process used for the thermal decomposition of ammonium bicarbonate solutions.

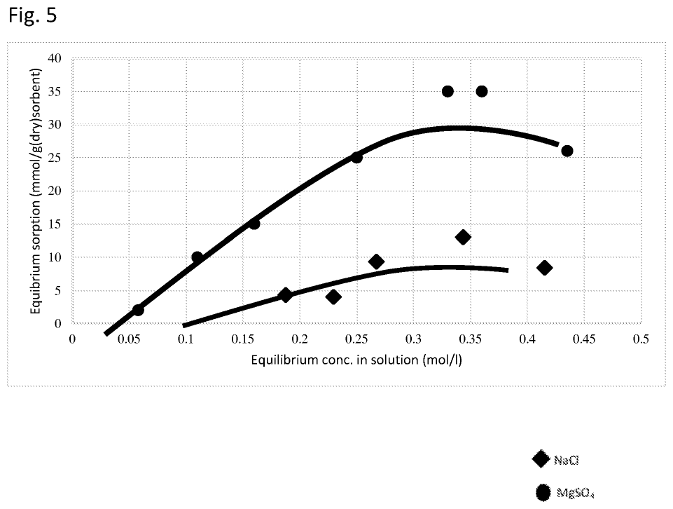

FIG. 5 shows a graphical representation of the typical adsorption results for crosslink hydrogel for MgSO₄ and NaCl at different concentrations.

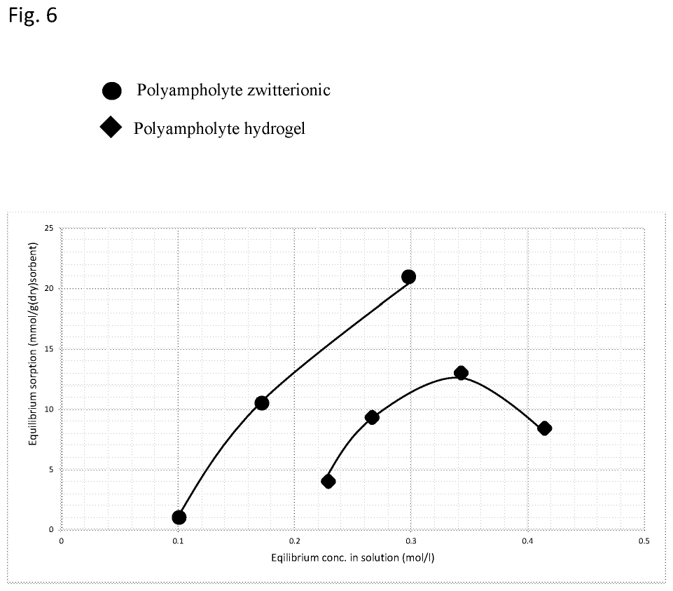

FIG. 6 shows typical adsorption equilibria for hydrogel and zwitterionic gels in a series of NaCl solutions.

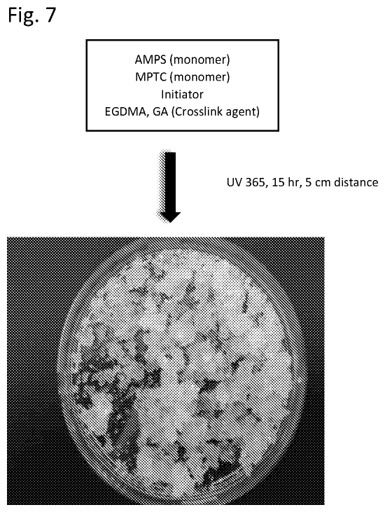

FIG. 7 shows the product of the polyampholytic resin synthesis.

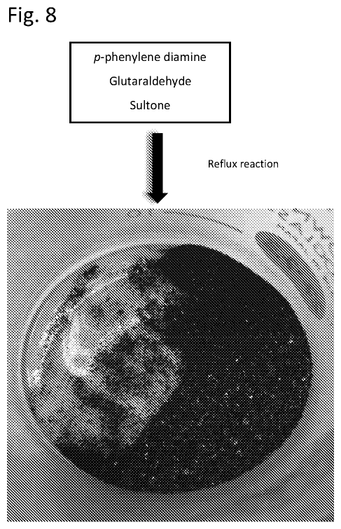

FIG. 8 shows the product of powdered zwitterionic ion exchange resin.

### DETAILED DESCRIPTION

According to a first aspect, disclosed is an ion exchange resin for high salt level water desalination, the resin comprising strong acid and strong base groups on the same polymer chain. In some forms the resin has a high concentration of strong acid and strong base groups on single polymer chains within the resin. In some forms the resin comprises either a chemically cross-linked ampholytic polymer resin or a cross-linked zwitterionic polymer resin on the same polymer chain, wherein the ampholytic polymer resin and the zwitterionic polymer resin each contain strong acid and base groups on the same polymer chain.

In some forms the ampholytic polymer resin was prepared by one-step co-polymerisation of an anionic monomer, a cationic monomer and a cross-linking agent using an initiator.

In some forms the anionic monomer comprises 2-acrylamido-2-methylpropanesulphonic acid sodium salt solution.

In some forms the cationic monomer comprises 3-(methacryloylamino) propyl-trimethylammonium chloride solution.

In some forms the crosslinking agent comprises ethylene glycol dimethacrylate.

In some forms the crosslinking agent and initiator comprises glutaraldehyde and alpha-ketoglutaric acid.

In some forms the ratio of anionic monomer:cationic monomer: cross linking agent is 1:1:2; with a lower level of a suitable radical initiator.

In some forms the strong acid and strong base groups are less than 10000 nm apart. In some forms the distance between the strong acid and base group is less than 20000 nm. In some forms the distance between the strong acid and base group on a single polymer is less than 5000 nm. In some forms the distance between the strong acid and the strong base group on a single polymer is in the nm range rather than the mm range.

Also disclosed is a process of regeneration of an ion-exchange resin, the process comprising washing the resin with concentrated ammonium bicarbonate solution.

In some forms the process is performed in situ.

The advantages of this technology may include:
improved efficiency of desalination
desalination of high concentration salt water such as seawater
sustainable and low energy desalination
regeneration of resin without separation of mixed resin beads
energy efficient regeneration of resin
regeneration of resin without exposure to strong acid or strong base

In some forms the resin is synthesised by synthesis of two different strong acid/strong base resins. In some forms the resins comprise a chemical cross-linked polyampholytic resin and a crosslinked zwitterionic polymer, both resins containing strong acid and base groups on the same polymer. These resins are provided in a mixed bead resin for desalination of water.

In some forms the chemical cross-linked polyampholytic resin and the crosslinked zwitterionic polymer are used independently.

In some forms the resin could be replaced by an inorganic ion exchange material, such as a suitable ion absorbing, powdered zeolite.

Disclosed also is a method of treating water using a resin having a high density of strong acid and strong base groups located on single polymers within the resin. Further disclosed is a method of regenerating the resin by washing in ammonium bicarbonate solution.

Referring to FIG. 1, the common ion exchange process, using mixtures of anion exchanging or cation exchanging beads, may behave very differently to ion exchange of both anions and cations on the same polymer. In the disclosed anion and cation exchange that occurs on the same polymer, the exchanging groups may be only nms apart. This may allow for simultaneous or otherwise more efficient ion exchange. This is distinct from ion exchange where the exchanging groups are on separate polymers and may be mms apart.

Referring to FIG. 2, disclosed is a method of regeneration which may be achieved in situ without separation of the mixed resin beads. The method comprises using concentrated ammonium bicarbonate solutions to displace the resin adsorbed Na⁺ and Cl⁻ ions with NH₄⁺ and HCO₃⁻ ions.

Mixed bead ion exchange resins having anion and cation exchange on the same polymer have not previously been developed because of the need to use acid and base washing to regenerate the resin, which necessarily requires separation of the two types of beads.

The use of ammonium bicarbonate (AB) offers an alternative method because it is a thermolytic salt, which is capable of decomposing in aqueous solution at low temperatures. The complete decomposition of AB into its individual constituents may be observed above 60° C., which is described by the reaction:

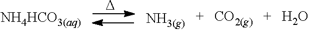

In some forms a bubble column evaporator (BCE) process could facilitate the thermal decomposition of AB solutions (both dilute and concentrated) at lower solution temperatures (of around 45° C.) and at a faster rate.

AB solutions have a wide variety of industrial applications. For instance, AB solution is used as a draw solution in desalination. Therefore, simultaneous separation of NH₃ and CO₂ gases from an aqueous NH₄HCO₃ solution with low energy consumption is a key issue for the commercialisation of FO desalination. Also, it has been recently demonstrated that AB solutions can be used in the regeneration step for ion exchange resins and this step is one of the biggest drawbacks with the use of ion exchange resins because it requires a large volume of acid and base. Hence, using an AB solution as regenerant can resolve this issue and finally, the decomposition of AB solution can provide drinking water for human consumption.

Recycling of the AB solutions may in some forms also be effectively carried out using membrane transport systems with hollow fibre membranes which may be used as an alternative for solution separation because it has many potential advantages, such as low operating pressure, temperature, ease of process scale-up, fast mass-transfer and durability of the membrane, over traditional evaporation or RO technology. Hollow fiber membranes also targeted for industrial applications (as opposed to medical ones, e.g., blood oxygenation) are available from a variety of sources.

Moreover, membrane distillation may be performed using commercial microporous hydrophobic hollow fibre polypropylene (PP) membranes to study the effects of various operating conditions including feed solution temperature, mass flow rate and concentration on gas removal and water recovery efficiencies

In some forms, membrane transport was used via a silicone based hollow fibre diffusion membrane and a PTFE hydrophobic pore membrane, for the controlled thermal decomposition and recycling of AB solutions.

Materials

Certified reagent grade chemical (>99% purity) ammonium bicarbonate (NH₄HCO₃) was supplied by Sigma-Aldrich and was used without further purification. Aqueous solutions were prepared using deionized water. Polytetrafluoroethylene (PTFE) and polydimethylsiloxane (PDMS) membrane contactors were supplied from Membranium (JSC RM Nanotech) and PermSelect (MedArray Inc), respectively. The peristaltic pump, model: WPX1-P1/8M2-J8-B, was supplied from Welco Co.,Ltd. Japan. The inlet AB solutions were pumped in at a rate of 40 mL/min in these experiments. For the highest area unit (2.1 m2) this corresponds to an average solution residence time of about 5 min.

Synthesis of strong acid and strong base polymer resins

### Example 1: Chemically x-linked Hydrogel

2-acrylamido-2-methylpropanesulphonic acid sodium salt solution (AMPS) (anionic monomer), 3-(methacryloylamino) propyl-trimethylammonium chloride solution (MPTC) (cationic monomer), ethylene glycol dimethacrylate (EGDMA) (crosslinking agent), 25% Glutaraldehyde (GA) and alpha-ketoglutaric acid (initiator) were used for synthesis. p-Phenylene diamine and glutaraldehyde and dimethyl formamide (DMF) and 1,3-propane sultone were used as reactants for synthesis of the zwitterionic compounds. Several salts; 98% sodium chloride, 99% sodium sulphate, magnesium chloride (AR grade) and magnesium sulphate (AR grade); were used to study swelling and electrical conductivity properties. All chemicals were purchased from Sigma-Aldrich, Australia as a reagent grade. 365 nm, 230 Volts, 8 Watts UV-lamp and 365 nm Ultraviolet Crosslinker replacement tubes were purchased from John Morris Scientific Pty Ltd.

Chemical structures of the monomers used to produce the polyampholytic hydrogel (a) and the zwitterionic resins (b).

(a) monomers for synthesis of polyampholytic hydrogel

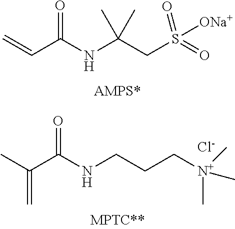

*2-acrylamide-2-methyl-1-propanesulfonic acid sodium salt solution

**3-(methacryloylamino)propyl-trimethylammonium chloride

(b) reactants for synthesis of zwitterionic resin

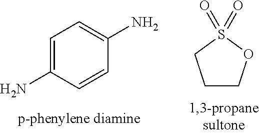 [SMILES: Nc1ccc(N)cc1 ; O=S1(=O)CCCO1]

### Example 2: Zwitterionic Polymer Resin

1,3-propane sultone, p-phenylene diamine, glutaraldehyde and dimethyl formamide were purchased from Sigma-Aldrich, Australia, each as reagent grade.

An alternative possible resin was selected from a range of zwitterionic polymers. The one selected is shown below. This resin was prepared using 5 mmol of p-phenylene diamine in 20 mL of DMF and 5 mmol of glutaraldehyde in 20 mL of DMF were prepared separately in a different beaker. The solution was mixed and refluxed at 80° C. for 1 hr. Then, 15 mmol of 1,3-propane sultone in 10 mL of DMF was added in the reaction and refluxed at 70° C. for 3 hr. The final product was washed several times with hot water to remove residual unreacted chemicals. The structure of the resin is given below:

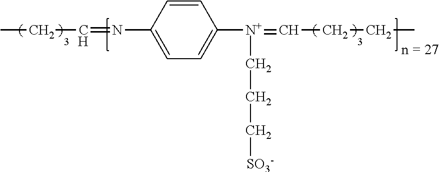

UV polymerisation method for production of the crosslinked ampholytic gel.

Several different reaction cells were tested for the UV polymerisation process to produce the polymer. The most suitable method was based on using an array of glass tubes of 1 cm diameter and 0.8 cm inner-diameter and of 10 cm length. Cross-linked polyampholytic resins were synthesized within the glass tubes using the one-step copolymerization of an anionic monomer, a cationic monomer and a crosslink agent (EGDMA). 2-oxoglutaric acid was used as initiator. Cross-linked polyampholytic resins were produced with a range of different composition ratio. The ratio of monomers are shown in the Table 1. 0.5 M NaCl was used to fill the reaction cell. The UV reactions used 8 Watts at 250 volts, with a 365 nm ultraviolet lamp, for 15 hours. After reaction, the product was immersed in water for 1 week to allow the product to equilibrate and to wash out the residue unreacted chemicals. The polymeric products showed a large absorption of water (i.e. swelling). As an example, swelling in water and a range of 0.2 M salts over several days is shown in FIG. 3 for the 1:1:1:2 resin sample. The equilibrium swelling in salts corresponded to about 90% water in the clear gel.

TABLE 1
Shows the ratio of monomers, initiator and crosslink agent used
in various synthesis reactions. In this table the initiator
concentrations 1-4 refer to the ratio of monomers and 0.25%
mole of initiator (i.e. for ‘1’, with ‘4’ corresponding to 1%).

| AMPS | MPTC | 2-oxoglutaric acid | EGDMA |
|---|---|---|---|
| 1 | 1 | 1 | — |
| 1 | 1 | 4 | — |
| 1 | 2 | 1 | — |
| 2 | 1 | 1 | — |
| 1 | 1 | 1 | 1 |
| 1 | 1 | 4 | 2 |
| 1 | 1 | 1 | 2 |
| 1 | 1 | 4 | 2 |

The results are shown in FIG. 3. Swelling of the 1:1:1:2 polyampholytic clear gel resin in water (far left side) and a range of 0.2 M salts from left to right MgCl₂, Na₂SO₄, MgSO₄ and NaCl at the far right.

Electrical Conductivity Measurements for NH₄HCO₃ solutions.

Ammonium bicarbonate solutions were prepared at a concentration of 0.03 M. Electrical conductivity values of all the solutions were measured using a EUTECH CON 700 Conductivity Bench, in a thermostat water bath at 25° C.

Study of the recovery of AB using different membranes in a single pass process.

0.03 M NH₄HCO₃ solutions were heated up to 80° C. to decompose the solution to ammonium (NH₃) and carbon dioxide gases (CO₂) just prior to entry into a membrane separator unit using an electrical gas heater (stainless steel tube wrapped with an electrical tape, Duo Tape Cat. No. is AWH-051-020, HTS/Amptek Company, Stafford, Tex., USA). The temperature of the inlet solution was continuously controlled and monitored using an AC Variac electrical supply and thermocouple. The room temperature air intake flowrate was fixed at 25 l.min-1. The gas phase counter-flow collected ammonia (NH₃) and carbon dioxide gases (CO₂), which were continuously separated through the membrane contactors by a diffusion process. The final solution was collected and cooled down to room temperature before measuring electrical conductivities using a EUTECH CON 700 Conductivity Bench. The recovery system is shown schematically in FIG. 4.

NH₄HCO₃ solution 60 is delivered to a heater column 61 which is measured by a thermometer 62 and controlled by a Variac AC 64. The solution is heated to 80° C. and delivered to membrane contactors 65 to separate it into ammonia and carbon dioxide 66 and residual water 67.

Polyampholytic and Polyzwitterionic Resins

The results of water swelling tests show that the composition of 1:1:1:2 (AMPS:MPTC:initiator:EGDMA) gave the lowest swollen property (30 times), of the polyampholytic resins, whereas the polyzwitterionic resin showed very little swelling. These two resins were studied further.

Ion adsorption equilibria were studied for both resins using monovalent (NaCl) and divalent (MgSO₄) salt solutions. Typical results for the polyampholytic resin are shown in FIG. 5 which graphs the absorption of crosslink hydrogel.

Similar adsorption isotherms were also obtained with the polyzwitterionic resin, with a maximum NaCl adsorption of about 28 mmol/g (dry wt). Both resins indicate enhanced adsorption capacity (as shown in FIG. 6) compared with typical results obtained using commercial mixed bead strong acid-strong base systems, which typically give up to about 5 mmol NaCl/g (dry wt).

Use of dense and porous HF membranes for AB solution decomposition and recycling

The experimental results show that the solubility of AB in the PDMS membrane is higher than in the PTFE membrane. Ammonia is a typical fast permeating compound formed by decomposition of AB solution and shows high permeability values, particularly in the polar polymers such as PDMS. PDMS membranes are known as dense membranes or solid membranes without voids or pores. Substances can pass through the dense membranes by a solution and diffusion process, so transferring substances from one side to the other. The mixture of gases dissolved in the feed solution were passed through the membrane module, via the inlet port, and then transferred through the walls of the hollow fibers, in this case ammonia and carbon dioxide, which were formed by pre-heating the AB solution feed. The gas species sweep out from the membrane walls, shell sides, as permeate and were then recovered in a bubble column containing cold water to restore the AB solution. The results show that the PDMS membranes, with 2.1 m² surface area, showed higher permeability to the gases, with about 57% AB recovery, whilst PTFE (0.5 m² surface area) gave a lower AB recovery in the system, of about 14%. However, the recovery rates when scaled by surface area were about the same.

These results indicate that for this flow-rate an HF membrane of about 4-5 m² would be required to almost completely remove the decomposed gases from a 0.03 M AB feed solution.

Referring to FIG. 7, the combination of an AMPS monomer, an MPTC monomer, an initiator and EGDMA, GA as a crosslink agent under UV365 for 15 hours at 5 cm distance results in the polyampholyte hydrogel shown in the Figure. The combination of p-phenylene diamine, glutaraldehyde and 1,3-propane sultone in a reflux reaction results in the polyamphlyte zwitterionic shown in FIG. 8.

It will be understood to persons skilled in the art that many other modifications may be made without departing from the spirit and scope of the process, and apparatus as disclosed herein.

In the claims which follow and in the preceding description, except where the context requires otherwise due to express language or necessary implication, the word “comprise” or variations thereof such as “comprises” or “comprising” is used in an inclusive sense, i.e. to specify the presence of the stated features but not to preclude the presence or addition of further features in various embodiments of the process and apparatus as disclosed herein.

1. An ion exchange resin comprising a polymer having strong acid and strong base groups on the same polymer.

2. An ion exchange resin as defined in claim 1, having a high density of strong acid and strong base groups.

3. An ion exchange resin as defined in claim 1, wherein the strong acid and strong base groups on one polymer are in close proximity to one another

4. An ion exchange resin as defined in claim 3, wherein the strong acid and strong base groups on one polymer are less than 10000 nm distance from one another

5. An ton exchange resin as defined in claim 1, the resin comprising either a chemically cross-linked ampholytic polymer resin or a cross-linked zwitterionic polymer resin, vs herein the ampholytic polymer resin and the zwitterionic polymer resin each contain strong acid and base groups on the same polymer chain.

6. An ion exchange resin as defined in claim 5, wherein the ampholytic polymer resin was prepared by one-step co-polymerisation of an anionic monomer, a cationic monomer and a cross-linking agent using an initiator.

7. An ion exchange resin as defined in claim 6, wherein the anionic monomer comprises 2-acrylamido-2-methylpropanesulphonic acid sodium salt solution.

8. An ion exchange resin as defined in claim 6, wherein the cationic monomer comprises 3-(methacryloylamino) propyl-trimethylammonium chloride solution.

9. An ion exchange resin as defined in claim 6, wherein the crosslinking agent comprises ethylene glycol dimethacrylate.

10. An ion exchange resin as defined in claim 6, wherein the crosslinking agent and initiator comprises glutaraldehyde and alpha-ketoglutaric acid

11. An ion exchange resin as defined in claim 6, wherein the ratio of anionic monomer: cationic monomer: cross linking agent is 1:1:2.

12. An ion exchange resin as defined in claim 1, wherein the resin is synthesised using p-phenylene diamine, dimethyl formamide (DMF), glutaraldehyde and 1,3-propane sultone.

13. A process of regeneration of an ion-exchange material, the process comprising washing the resin with concentrated ammonium bicarbonate solution.

14. A process of regeneration as defined in claim 13, wherein the process is performed in situ.

15. A process of regeneration as defined in claim 13, wherein the ion-exchange material is a resin comprising a strong acid group and a strong base group on single polymers within the resin

16. A process of regeneration as defined in claim 13, wherein the ion-exchange material is an inorganic ion exchange material.

17. A process of regeneration as defined in claim 16, wherein the inorganic ion exchange material is a zeolite.
